(19) United States
(12) Patent Application Publication
(10) Pub. No.: US 2015/0092400 A1
(43) Pub. Date: Apr. 2, 2015

(54) LIGHTING GROUP

(71) Applicant: GPIII S.r.L., Crevalcore (BO) (IT)

(72) Inventor: Donato Vincenzi, Ferrara (IT)

(21) Appl. No.: 14/394,997

(22) PCT Filed: Apr. 16, 2013
(86) PCT No.: PCT/IB2013/053007

§ 371 Date: Oct. 16, 2014

(30) Foreign Application Priority Data
Apr. 17, 2012 (IT) BO2012A000206

(51) Int. Cl. F21S 9/03; F21V 7/06

(52) U.S. Cl. CPC F21S 9/035; F21V 7/06; F21W 2131/10
USPC 362/183

(57) ABSTRACT

A lighting group (1, 10), comprising: a frame (2); a support (3) which is constrained to the frame (2); a photovoltaic cell (4) which is constrained to the support (3); an artificial light source (5). In particular, the support (3) is provided with a reflective surface (6) arranged and conformed such as to convey solar rays (R) towards the photovoltaic cell (4); the artificial light source (5) is constrained to the support (3) such as to emit a light beam (50) which reflects against the reflective surface (6) and propagates towards the outside; the support (3) is rotatable about an axis such as to be arranged such as to maximise a quantity of solar rays (R) which reflect against the reflective surface (6) and are conveyed towards the photovoltaic cell (4) and in order to regulate the direction of the light beam (50) emitted outwards from the artificial light source (5).

### FIELD OF INVENTION

The present invention relates to the technical sector concerning devices which convert solar energy into electrical energy.

### DESCRIPTION OF PRIOR ART

A device is known which converts solar energy into electrical energy, which powers a lamp for night-time illumination; the area to be illuminated is usually located where an electrical energy distribution network is absent (for example particularly difficult-to-reach and/or mountainous places).

The known conversion device comprises a first optical group and a plurality of photovoltaic cells; the first optical group is designed to convey solar rays towards the photovoltaic cells.

The lamp is provided with a source of artificial light and a housing which receives the artificial light source and which is provided with a second optical group for conveying the reflected light towards the area to be illuminated; in particular, the second optical group can be a reflective surface which clads an internal wall of the housing.

The group formed by the conversion device of solar energy into electrical energy and the lamp is however cumbersome and expensive.

### SUMMARY OF THE INVENTION

The aim of the present invention consists in obviating the above-mentioned drawbacks.

The aim is attained by providing a lighting group according to claim 1.

According to claim 1, the disclosed lighting group comprises: a frame; a support which is constrained to the frame; a photovoltaic cell which is constrained to the support; an artificial light source;

in particular, the support is provided with a reflective surface arranged and conformed such as to convey solar rays towards the photovoltaic cell; the artificial light source is constrained to the support such as to emit a light beam which reflects against the reflective surface and propagates towards the outside; the support is rotatable about an axis such as to be arranged such as to maximise a quantity of solar rays which reflect against the reflective surface and are conveyed towards the photovoltaic cell, and in order to regulate the direction of the light beam emitted outwards from the artificial light source.

The lighting group of the present invention is compact and has limited costs with respect to the prior art.

It is in fact possible to constrain both the photovoltaic cell and the light source to the support. Consequently, further housings are not necessary for the light source; nor is the presence of the actual lamp pole.

The lighting group of the invention further exhibits a pleasant aesthetic aspect, differently to the prior art, and, from the architectural point of view, is optimally integrated in structures that already exist.

The group of the invention further also exhibits the advantage of performing a multiplicity of functions (for example shading) as will be more fully clarified in the following.

### BRIEF DESCRIPTION OF THE DRAWINGS

Specific embodiments of the invention will be described in the following part of the description, in accordance with what is set out in the claims and with the aid of the appended tables of drawings, in which:

FIG. 1 is a sectioned lateral view of a lighting group of the present invention (in which some parts have been removed better to evidence others), in a first operating situation;

FIG. 2 illustrates the same view as in FIG. 1, in a second operating situation;

FIG. 3 is a sectioned lateral view of a preferred embodiment of the invention;

FIG. 4 is a view as in FIG. 3, in a different operating situation;

FIG. 5 is a schematic plan view of a detail of a preferred embodiment of the invention;

FIG. 6 is a perspective view of a preferred embodiment of the invention.

### DESCRIPTION OF PREFERRED EMBODIMENTS

With reference to the accompanying figures, 1 and 10 denote a lighting group according to the present invention.

The group 1, 10 comprises: a frame 2 (visible in FIG. 6); a support 3 which is constrained to the frame 2; a photovoltaic cell 4 which is constrained to the support 3; an artificial light source 5.

In particular, the support 3 is provided with a reflective surface 6 arranged and conformed for conveying the solar rays R towards the photovoltaic cell 4.

The artificial light source 5 is constrained to the support 3 such as to emit a light beam 50 which reflects against the reflective surface 6 and propagates towards the outside; further, the support 3 is rotatable about an axis such as to be arranged such as to maximise a quantity of solar rays R which reflect against the reflective surface 6 and are conveyed towards the photovoltaic cell 4 and in order to regulate the direction of the light beam 50 emitted outwards from the artificial light source 5.

The lighting group 1, 10 is advantageously particularly compact and inexpensive with respect to the prior art. In fact, the artificial light source 5 is constrained to the support 3 to which the photovoltaic cell 4 is also constrained.

Further, the proposed solution has been shown to be particularly flexible and versatile, as it enables regulating the light beam 50 emitted by the artificial light source 5 towards the outside, according to needs.

In particular, the movement (rotatable) of the support 3 with respect to the frame 2 can be limited to a degree of freedom. In other words, the support 3 is hinged to the frame 2 at a hinge axis. In particular, the hinge axis passes through the support 3.

The photovoltaic cell 4 and the source of artificial light 5, on the other hand, can be for example constrained to the support 3 so as to be fixed thereto.

In particular, in the accompanying figures the support 1 forms a box element comprising at least a transparent surface 30 (for example made of glass or plastic) for protection, in order to enable access of the solar rays R and outlet of the light beam 50 emitted by the source of artificial light 5.

In the preferred embodiment of the invention, the group 1, 10 comprises a plurality of photovoltaic cells 4 and a plurality of sources of artificial light 5.

The group 1, 10 of the present invention can further comprise movement means 7 (see FIG. 3) for enabling the movement of the support 3 (and therefore the solid movement of the photovoltaic cells 4 and the artificial light source 5) with respect to the frame 2.

The movement means 7 can comprise for example at least a pulley 70 having a double belt or double chain 72 and at least a hollow shaft 71 (arranged at the above-mentioned hinge axis) connected to the pulley 70 and the support, activatable to enable rotation of the support 3 with respect to the frame 2 (see in particular the arrows of FIG. 3).

The movement means 7 can comprise at least an engine (not illustrated) for enabling movement of the pulley 71, with the aim of enabling “solar tracking” of the support 3; in this way it is possible to maximise the quantity of solar rays R which, reflecting against the reflective surface 6, are conveyed towards the photovoltaic cell 4.

Further, the movement means 7 can comprise a manual movement system (not illustrated), in order to enable movement of the pulley 71 with the aim of regulating the direction of the support 3 and therefore of the light beam 50 emitted by the source of artificial light 5.

For example, the light beam 50 can be regulated to illuminate the front of a building at night.

With reference to the figures, the source of artificial light 5 is arranged adjacent or in a relation of strict vicinity with respect to the photovoltaic cell 4. In detail, the source of artificial light 5 can be arranged at a minimum distance from the photovoltaic cell 4.

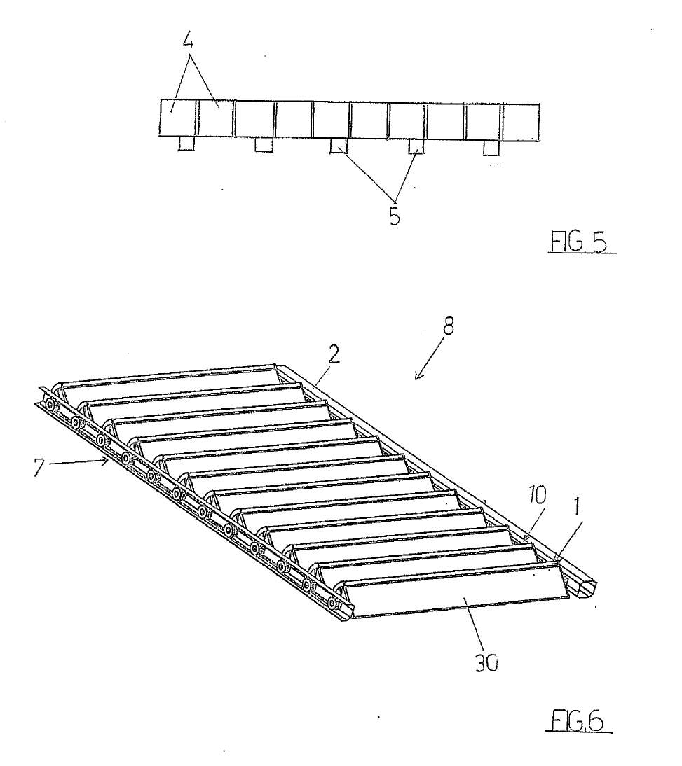

In the detail illustrated in FIG. 5, a plurality of photovoltaic cells 4 (for example made of silicon) can be provided, arranged in at least a row. Still with reference to the detail of FIG. 5, a plurality of artificial light sources 5 is included, in particular one for each two photovoltaic cells 4.

The reflective surface 6 can exhibit, for example, a parabolic profile (as in the case illustrated in the appended figures). Specifically, the reflective surface 6 can comprise at least a reflective surface, which for example is identified in a reflective film.

In a preferred embodiment of the invention, each artificial light source 5 comprises at least a LED.

This detail advantageously enables not only modulating the light intensity of the at least a LED without modifying the chromatic performance of the source (by means of a suitable control board), but also reducing the energetic consumption, as well as reducing the maintenance intervals and replacement of the light sources to a minimum.

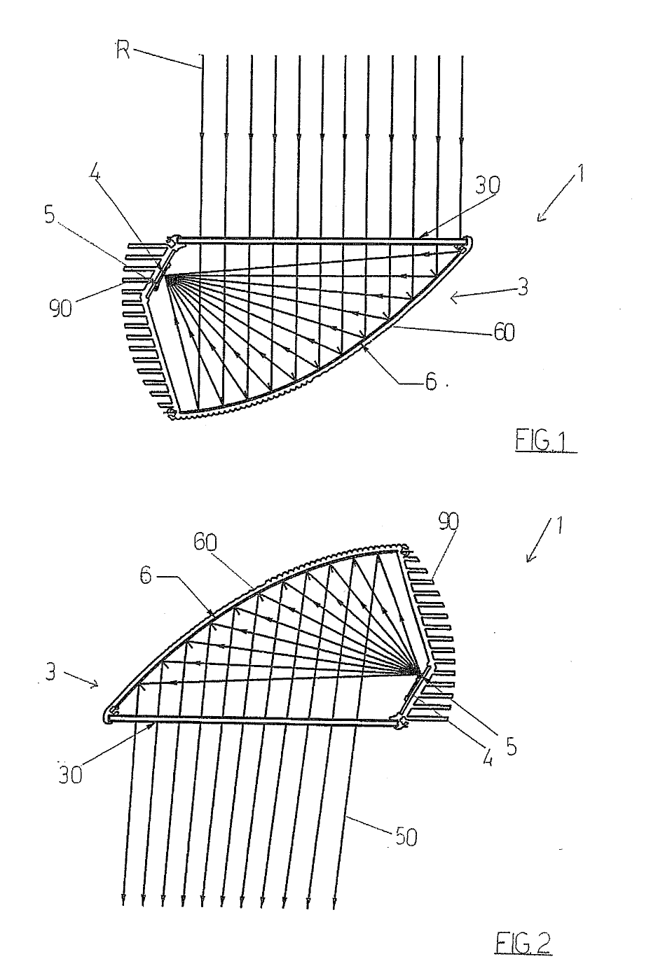

In the embodiment of the invention, the support 3 further comprises means for dissipating the heat, arranged at the photovoltaic cell 4 in order to prevent over-heating. The heat dissipating means can comprise a plurality of fins, visible for example in FIGS. 1 and 2.

In a preferred embodiment, the heat dissipating means further comprise at least a conduit (not illustrated) for passage of a cooling fluid, arranged adjacent to the fins 90.

The fluid flowing in the conduit can be further used for conversion of the solar radiation into heat energy usable for example in civil or industrial situations.

In a different embodiment, the conduit can alternatively be arranged internally of the support 3.

In a preferred embodiment of the invention, the support 3 can further comprise a conduit (not illustrated) arranged such as to dispense a fluid (for example water) at the transparent surface 30 of the support 3, in order to enable periodic cleaning thereof.

The group 1, 10 can further comprise a battery (not illustrated) for accumulating the electrical energy via the photovoltaic cell 4. In this case, at least a light source 5 can be connected to the battery, in order to be supplied thereby. This detail enables using the group 1, 10 also in places where the connection of the electric distribution network is hard to achieve or absent.

The present invention further relates to a system 8 comprising a plurality of groups 1, 10 as described herein above.

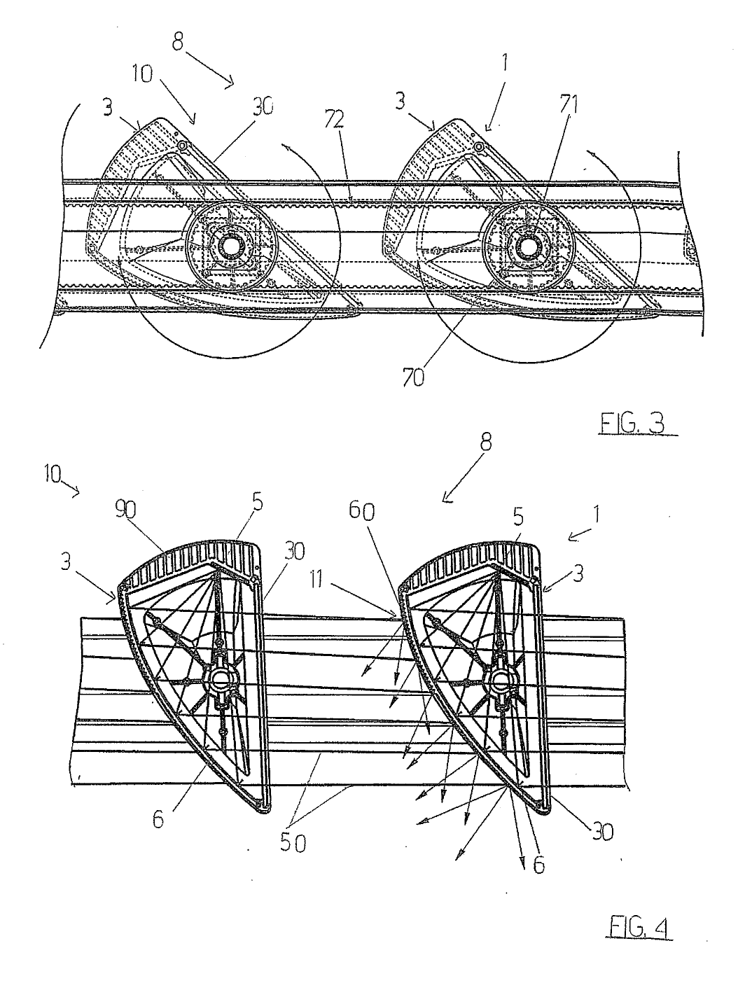

In particular, in the embodiment illustrated in FIGS. 3 and 4, the plurality of groups 1, 10 comprises at least a first group 1 and a second group 10.

In the specific case, at least the support 3 of the first group 1, comprises a wall 11 which on a side thereof is provided with the reflective surface 6 and which on the opposite side is provided with a diffusing surface 60 designed to create a diffused light when a light beam 50 reflects against the diffusing surface 60.

Further, the support 3 of the first group 1 and the support 3 of the second group 10 are arranged adjacent such that a light beam 50 emitted by the artificial light source 5 of the second group 10 and which reflects against the reflective surface 6 of the second group 10 is further reflected, subsequently, from the diffusion surface 60 of the support of the first group 1 such as to create a diffused light (see in particular FIG. 4).

The system 8 can clearly comprise more than two groups 1, 10 arranged adjacent (such that the relative hinge axes are aligned), the support 3 of each of which can comprise the wall 11 which on a side thereof is provided with the reflective surface 6 and which on the opposite side is provided with a diffusion surface 60.

This characteristic advantageously makes the invention more versatile with respect to the prior art, especially in the preferred embodiment in which the reflective surface 6 exhibits a parabolic profile. In fact, according to needs it is practically and rapidly possible to obtain both a direct light (see FIG. 2) and a diffused light (as in the case of FIG. 4) according to the rotation of each group 1, 10 with respect to the frame 2.

The present invention further relates to a sun shade comprising a system 8 such as the one described above. In this case, the support 3 of each group 1, 10 is a sunshade fin, comprising a housing having a longitudinal development (see in particular FIG. 6).

For example, the sunshade cover can be used for realising a veranda. In this case, the groups 1,10 can be used for generating electrical energy during the day when there is a clear sky, while in the evening, at night and/or during the day, with the sky cloudy, they can be used as a source of illumination.

Further, the invention relates to a roof and a canopy both comprising the above-described sunshade.

The system 8 of the present invention is advantageously not only versatile but also poly-functional according to needs and/or meteorological conditions.

The foregoing has been described by way of non-limiting example, and any eventual constructional variants are understood to fall within the protective scope of the present technical solution, as claimed in the following.

1. A lighting group, comprising:
a frame;
a support which is constrained to the frame;
a photovoltaic cell which is constrained to the support;
an artificial light source;
wherein:
the support is provided with a reflective surface arranged and conformed such as to convey solar rays towards the photovoltaic cell;
the artificial light source is constrained to the support such as to emit a light beam which reflects against the reflective surface and propagates towards the outside;
the support is rotatable about an axis such as to be arranged such as to maximise a quantity of solar rays which reflect against the reflective surface and are conveyed towards the photovoltaic cell and in order to regulate the direction of the light beam emitted outwards from the artificial light source.

2. The group of claim 1, wherein the artificial light source is arranged adjacent to or in a relation of strict vicinity with the photovoltaic cell.

3. The group of claim 1, wherein the reflective surface exhibits a parabolic profile.

4. The group of claim 1, wherein the artificial light source comprises at least a LED.

5. A system comprising a plurality of groups according to claim 1.

6. The system of claim 5, wherein the plurality of groups comprises at least a first group and a second group; and wherein:
at least the support of the first group comprises a wall which on a side thereof is provided with the reflective surface and on the opposite side thereof is provided with a diffusing surface designed such as to create a diffused light when a light beam reflects against the diffusing surface; and
the support of the first group and the support of the second group are arranged adjacent such that a light beam emitted by the artificial light source of the second group and which reflects against the reflective surface of the second group is further reflected, subsequently, by the diffusing surface of the support of the first group such as to create a diffused light.

7. A sunshade covering comprising a system according to claim 5, wherein the support of each group is a sunshade slat and comprises a housing having a longitudinal development.

8. A roof comprising the sunshade covering according to claim 7.

9. A shelter comprising the sunshade covering according to claim 7.
